(19) United States
(12) Patent Application Publication
(10) Pub. No.: US 2006/0175891 A1
(43) Pub. Date: Aug. 10, 2006

(54) Decorative tire side wall cover

(76) Inventor: Ruben Diaz, Santa Rosa, CA (US)

Correspondence Address: KLEINBERG & LERNER, LLP, 2049 CENTURY PARK EAST, SUITE 1080, LOS ANGELES, CA, 90067, US

(21) Appl. No.: 11/256,448

(22) Filed: Oct. 24, 2005

Related U.S. Application Data
(60) Provisional application No. 60/649,530, filed on Feb. 4, 2005.

(51) Int. Cl. B60B 7/01

(52) U.S. Cl. 301/37.22

(57) ABSTRACT

A vehicular tire sidewall cover is adapted to fit between the rim of a vehicle wheel and a tire mounted thereon. The cover has annular ribs adjacent to the tire and rim to assure an airtight seal and is of sufficiently sturdy elastomer to allow a bias against the tire. An alternative embodiment includes an overhanging lip which protects the wheel rim from dents and scrape

### CROSS REFERENCE TO RELATED APPLICATIONS

This is a continuation-in-part of my pending provisional application Ser. No. 60/649,530, filed Feb. 4, 2005.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

This invention relates to the field of automotive aftermarket accessories and, more particularly, an accessory tire side wall cover that can be colored or patterned to suit the personal preferences of the owner of a vehicle, as well as protect the outer edge of the vehicle's wheel rim.

2. Description of the Related Art

Motor vehicle operators have, for many years, had a deep interest in providing aftermarket accessories that would personalize their vehicles and achieve distinctive appearances. In prior years, tire manufacturers provided tires with white or colored side walls as an alternative to the all black tire that was regularly produced. Most recently manufacturers have supplied tires with a colored tread.

When the white side wall was in great demand, many manufacturers provided tires with one white side wall and one black side wall so that the owner could choose which side wall would be displayed when the tire was mounted on a vehicle. However, in recent years, manufacturers have been providing all black tires even though the desire for non-black side walls has not disappeared.

Accessory white and colored side wall covers have been provided in the past. These aftermarket accessory side walls generally were composed of fairly soft rubber compounds and were mounted adjacent to the tire, between the bead of the installed tire and the wheel outer rim. The side wall covers tended to be thin and flexible and, in operation, could lift away from the surface of the underlying tire or could flutter under the aerodynamic stresses of wheel rotation.

The aftermarket automotive industries recent drive to accessories and personalize vehicles has lead to the production of very unique and very expensive wheels for all vehicle makes. These very expensive wheels are prone to damage from everyday use, specifically damage to the outer edge of the wheel caused by curbs while parallel parking the vehicle. Without adequate protection, repeated abrasion and scuffing from contact with curbs leads to unsightly damage of the wheel and can ultimately weaken the side wall of the wheel so that it is more prone to failure.

### SUMMARY OF THE INVENTION

According to the present invention, a novel accessory side wall cover and protector is provided that can be installed adjacent the tire. The cover, having an annular shape, is composed of a fairly stiff rubber composition and is molded to be biased against the tire. An outer edge of the cover at the inner periphery of the annulus rests upon the wheel and circumferential ribs found on the inner and outer periphery of the cover engage the outer wall of the tire and the inner wall of the wheel rim to retain the cover against the wheel and tire as the tire is inflated.

In an alternative embodiment, the outer edge of the cover at the outer periphery of the annulus includes a lip that covers the outer edge of the wheel rim with a fairly stiff rubber composition providing protection to the wheel rim from scuffing and abrasion.

The cover is relatively thick in the area most likely to encounter abrasion from curbs and other structures that might damage the tire and wheel sidewalls. At the outermost periphery of the annulus, which is the thinnest portion of the cover, there is an interior groove that further biases the outer periphery of the cover against the tire wall to minimize the risk of separation from the tire at high rotational speeds.

It is, therefore, an object of the invention to provide a tire accessory item that imparts the look of a colored sidewall to a conventional black side wall tire.

It is a further object of invention to provide an annular protective side wall cover for the outer edge of the wheel rim.

It is a further object of invention to provide an annular protective side wall cover for a tire.

It is yet another object of the invention to provide an accessory tire cover that includes artistic elements of design or color to distinguish the vehicle upon which it is mounted from other vehicles.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a front view of the side wall cover mounted to a wheel and tire assembly;

FIG. 2 is a cross sectional view of the assembly of FIG. 1, taken along the line 2-2 in the direction of the appended arrows;

FIG. 3 is a side section view of a side wall cover according to the present invention;

FIG. 4 is a cross sectional view of a portion of an alternative side wall cover with a wheel rim protective flap mounted to a wheel and tire assembly; and

FIG. 5 is a side section view of the alternative side wall cover of FIG. 4.

### DETAILED DESCRIPTION OF THE INVENTION

Turning first to FIG. 1, there is shown an automotive wheel/tire assembly 10 with an annular side wall cover 12 according to the present invention mounted adjacent a tire 14 on a typical wheel 16. As seen in FIG. 1, the cover 12 is designed to look as if it is integral with the side wall of the tire 14.

In the preferred embodiment, approximately one half of the tire side wall 14 is covered by the side wall cover 12 which will generally be in a color that contrasts with the normal black color of the tire 14. For a classical look, the cover 12 would be white. Individual personal preferences might suggest a broader color palette to express a more individualistic ownership style.

Depending, of course, upon the design of the tire and the height of the tire side wall, the cover 14 could protect the side wall to a greater or lesser extent. What is important is that the vehicle owner has the option for greater customization of the appearance of the vehicle insofar as the wheels and tires are concerned.

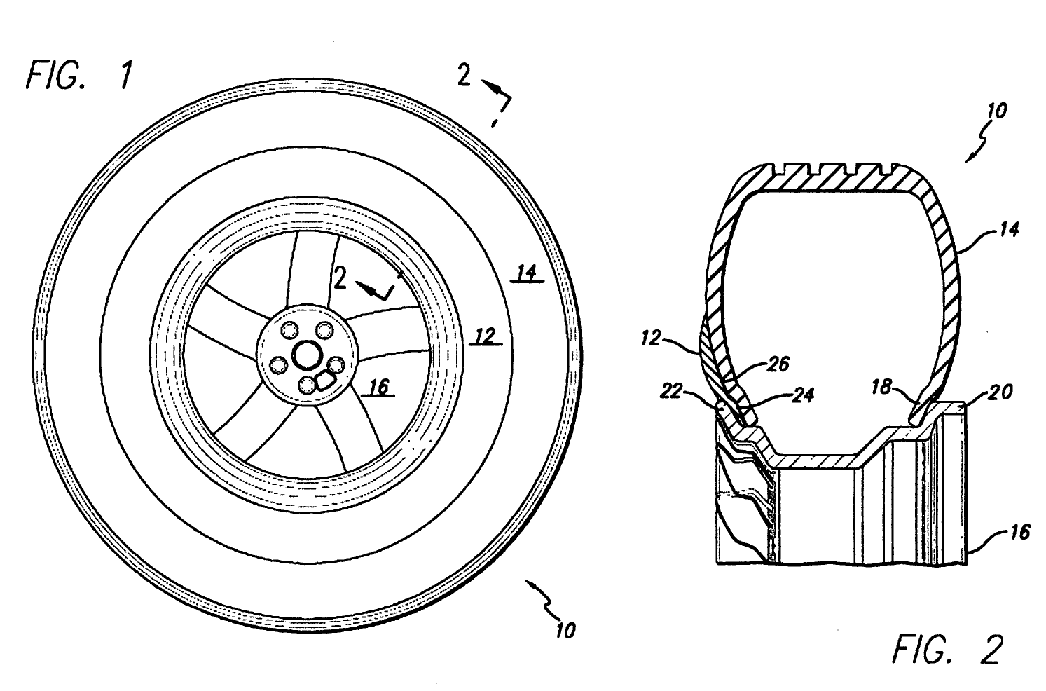

FIG. 2 is a cross sectional view of the wheel/tire assembly 10 of FIG. 1, taken along line 2-2. As shown, the tire 14 is typically mounted upon the wheel 16 with the tire bead 18 resting in the wheel well 20. The tire bead 18 and the wheel well 20 cooperate to form an airtight seal so that the tire 14 retains inflation.

As shown, the annular cover 12 is designed to be held in place between the tire bead 18 and the wheel's outer rim 22 by the air pressure within the tire 14. The cover 12 can be stretched to fit over the wheel's outer rim 22. The cover 12 is sized to have approximately the same inside diameter as the tire it is to protect. Although the example shown is a tubeless tire, the presence of an inner tube would not materially alter the relationships. The cross section profile of the cover 12, which is convex on the outer surface and concave on the inner surface, includes a strong bias, urging the cover 12 against the tire 14 side wall.

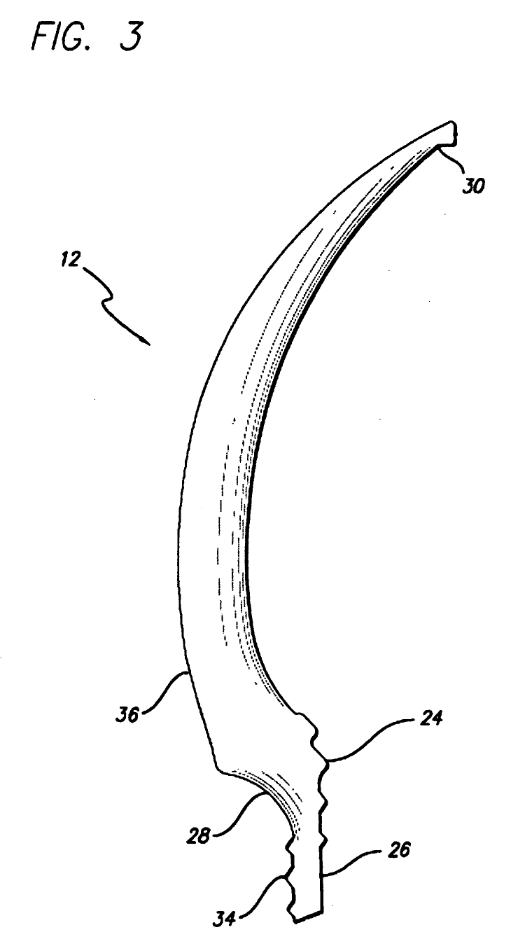

A series of inner concentric ribs 24, and outer concentric ribs 34, found on the cover 12 near the inner periphery 26 serve as barriers against any air leaks as between the tire bead 18, outer rim 22, and the cover 12 and to prevent extrusion of the cover 12 should the tire become overinflated. The specific features of the cover are best seen in FIG. 3, below.

Turning to FIG. 3, there is shown a side section view of the tire cover 12 of FIG. 1. In FIG. 3, some of the details of construction of the cover 12 can be better seen. At the inner periphery 26 of the cover 12, the inner circumferential ribs 24 and the outer circumferential ribs 34 can be seen. These ribs 24 and 34 have the dual functions of enabling the cover 12 to be better held in place between the tire bead 18 and wheel rim 22, and also the ability to seal any inadvertent air leaks that may occur between the tire bead 18, wheel rim 22, and the cover 12.

The outer surface 36 of the cover 12 has an outer peripheral groove 28 into which the wheel rim 22 can fit. The cover 12 is molded with a curvature that heavily biases the cover 12 against the side wall of the tire 14. At the uppermost edge of the cover 12, an inner circumferential groove 30 creates a more flexible contact point which is urged against the tire 14 side wall. The provision of the circumferential groove 30 also allows for greater conformation of the cover 12 to the tire 14 sidewall.

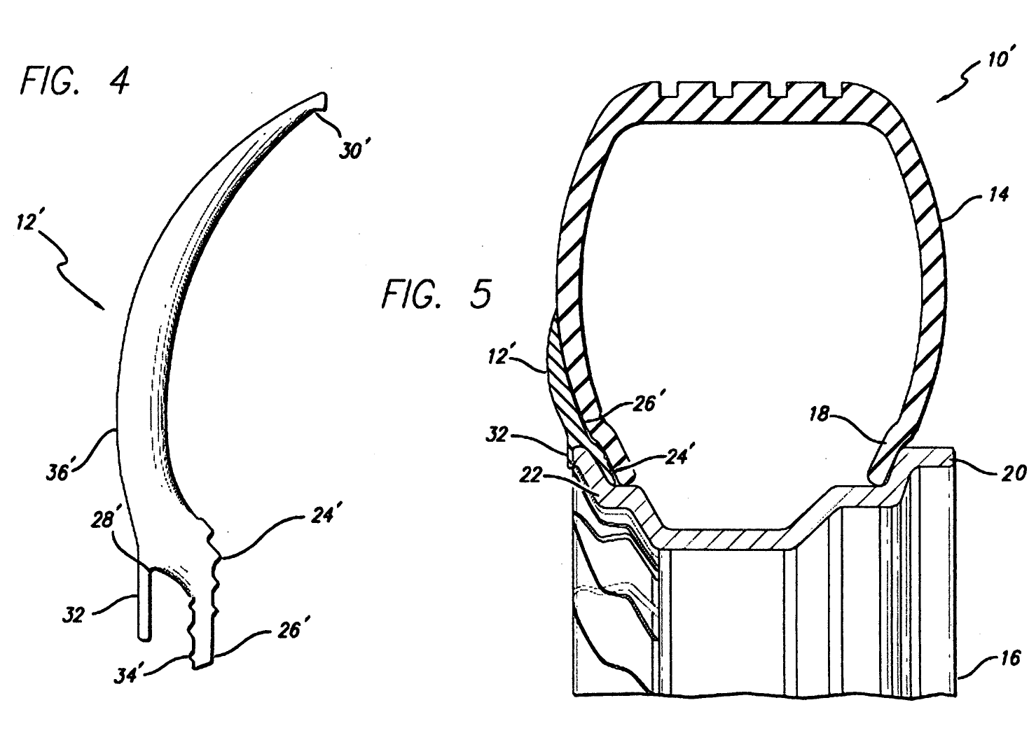

FIGS. 4 depicts an alternative embodiment of a cover and wheel/tire assembly 10′. The alternative embodiment adds to a cover 12′, an outer wheel rim protector 32 as an overhanging lip or flap. The wheel rim protector 32 covers the outer wheel rim 22 and helps protect the wheel rim 22 from contact with curbs, road debris, and other harmful elements.

In FIG. 5 there is shown in cross section view, the alternative embodiment tire cover 10′ of FIG. 4. An outer peripheral groove 28′ into which the wheel outer rim 22 can fit, is complemented by a wheel protector lip or flap 32, which encompasses the entire outer wheel rim 22. The other elements of the tire cover 10′ bear similar reference numbers to the corresponding elements of FIG. 1, modified by the addition of a prime (′).

The selection of an appropriate rubber formulation for flexibility and stiffness is a design choice but should be optimized to maintain the cover 12 smoothly against the tire 14 side wall. Further, the cover is colored to suit the esthetic taste of the owner and may include combinations of color or patterns of color. These can be accomplished without fear of compromising the integrity and strength of the tire itself, which may impose restraints on such features as color, flexibility and hardness.

The tire cover of the present invention is installed on a fully or partially deflated wheel and tire assembly. The cover is flexible enough to be stretched over the rim of the wheel so that it can be positioned adjacent the tire. As the tire inflates, the tire bead is seated and continued inflation secures the cover between the tire and the rim. When the tire is fully inflated, the cover is held at its base between the tire and the wheel rim by the circumferential ribs molded on both sides of the cover.

The alternative embodiment containing the outer rim protector may be installed on a fully or partially deflated wheel and tire assembly. The cover is flexible enough to fit over the outer rim and adjacent to the tire. As the tire is inflated the pressure secures the cover between the tire and the outer rim. When the tire is fully inflated, the cover is held at its base between the tire and the wheel rim and, at its outer periphery, is held firmly against the tire sidewall.

Variations and modifications will occur to those skilled in the art and, accordingly, the breadth of the invention should be limited only by the scope of the claims appended hereto.

What is claimed as new is:

1. A vehicle tire sidewall cover comprising:
a) an elastomeric annulus having an inner diameter substantially equal to the diameter of the inner periphery of the vehicle tire and an outer diameter less than the diameter of the outer periphery of the vehicle tire;
b) an annulus inner wall adapted to be mounted adjacent the vehicle tire and positioned between the vehicle tire and a vehicle wheel rim;
c) an annulus outer wall adapted to be mounted adjacent the vehicle wheel rim;
d) at least one annular rib on said annulus inner wall near the inner periphery and adapted to be positioned adjacent the tire sidewall; and
e) at least one annular groove in said annulus inner wall near the outer periphery thereof to enable the peripheral edge of said annulus to conform to the surface of the vehicle tire.

2. A vehicle tire sidewall cover according to claim 1, wherein said annulus inner wall near the inner periphery has additional annular ribs for forming an airtight seal between said annulus inner wall and the tire sidewall.

3. A vehicle tire sidewall cover according to claim 1, wherein said annulus outer wall near the inner periphery has at least an annular rib for forming an airtight seal between said annulus outer wall and the wheel rim.

4. A vehicle tire sidewall cover according to claim 1, wherein said annulus outer wall is substantially convex in cross section.

5. A vehicle tire sidewall cover according to claim 1, wherein said annulus inner wall is substantially concave in cross section.

6. A vehicle tire sidewall cover according to claim 1, wherein said annulus is comprised of three regions, a first region including said inner periphery, a second region including said outer periphery and a central region between said first and second regions; said central region having a cross sectional width greater than said first and second regions, said annulus including a bias urging it into close contact with the sidewall of the vehicle tire sidewall.

7. A sidewall cover for a vehicle tire comprising:
a) an elastomeric annulus having an inner diameter substantially equal to the diameter of the inner periphery of a vehicle tire and an outer diameter less than the diameter of the outer periphery of the vehicle tire;
b) an annulus inner wall adapted to be mounted adjacent the vehicle tire and positioned between the vehicle tire and the vehicle wheel rim;
c) an annulus outer wall lip adapted to be mounted over the vehicle wheel rim so as to form a protective cover over the outer periphery of the wheel rim,
d) an annulus outer wall adapted to be positioned between the vehicle wheel rim and the vehicle tire;
e) at least one annular rib on said annulus inner wall near the inner periphery of said annulus and adapted to be positioned adjacent the tire bead; and
f) at least one annular groove in said annulus inner wall near the outer periphery thereof to enable the peripheral edge of said annulus to conform to the surface of the vehicle tire.

8. A vehicle tire sidewall cover according to claim 7, wherein said annulus inner wall near the inner periphery has additional annular ribs for forming an airtight seal between said annulus outer wall and the rim.

9. A vehicle tire sidewall cover according to claim 7, wherein said annulus outer wall near the inner periphery has at least an annular rib for forming an airtight seal between said annulus outer wall and the wheel rim.

10. A vehicle tire sidewall cover according to claim 7, wherein said annulus outer wall is substantially convex in cross section.

11. A vehicle tire sidewall cover according to claim 7, wherein said annulus inner wall is substantially concave in cross section.

12. A vehicle tire sidewall cover according to claim 7, wherein said annulus outer wall mounted around said vehicle rim also provides a protective barrier for the vehicle wheel rim.

13. A vehicle tire sidewall cover according to claim 7, wherein said annulus is comprised of three regions, a first region including said inner periphery, a second region including said outer periphery and a central region between said first and second regions;
said central region having a cross sectional width greater than said first and second regions, said annulus including a bias urging it into close contact with the sidewall of the vehicle tire sidewall.
